(19) United States
(12) Patent Application Publication
(10) Pub. No.: US 2013/0204883 A1
(43) Pub. Date: Aug. 8, 2013

(54) COMPUTATION OF TOP-K PAIRWISE CO-OCCURRENCE STATISTICS

(71) Applicants: Alice Xiao-Zhou Zheng, Seattle, WA (US); Yucheng Low, Pittsburgh, PA (US)

(72) Inventors: Alice Xiao-Zhou Zheng, Seattle, WA (US); Yucheng Low, Pittsburgh, PA (US)

(73) Assignee: MICROSOFT CORPORATION, Redmond, WA (US)

(21) Appl. No.: 13/364,328

(22) Filed: Feb. 2, 2012

(51) Int. Cl. G06F 17/30

(52) U.S. Cl. 707/752; 707/E17.058

(57) ABSTRACT

Various technologies described herein pertain to computing top-K pairwise co-occurrence statistics using an upper bounding heuristic. Upper bound values of a co-occurrence statistic for items in a set can be computed based on a query item, and items can be sorted into an order. The items and the query item are represented by respective portions of a tensor. An item from the order associated with a highest upper bound value can be selected, an actual value of the co-occurrence statistic can be computed for the selected item, the upper bound value for the selected item can be replaced with the actual value for the selected item, and the selected item can be repositioned in the order. When the top-K items in the order lack an item associated with an upper bound value, the top-K items and actual values of the co-occurrence statistic for the top-K items can be outputted.

### BACKGROUND

Co-occurrence statistics are commonly calculated and used in various processing tasks. For example, given a corpus of text documents and a query word, it can be desired to quickly compute the top-K words from the corpus of text documents that most frequently co-occur with the query word. By way of illustration, the corpus of text documents can be represented by a matrix, where each row in the sparse matrix can represent a document and each column can represent a word. Following this illustration, the query word can be represented by a corresponding word vector (e.g., a particular column of the matrix). The top-K words determined to co-occur with the query word can be employed in processing tasks such as, for instance, web searches, advertisement placement, and so forth.

In some conventional approaches for identifying the top-K words that co-occur with the query word, co-occurrence statistics are computed between the query word and each word in the corpus of text documents. For instance, respective actual values of an inner product between the word-document vector that represents the query word and the remaining word-document vectors that represent each other word in the corpus of text documents can be computed, from which the top-K words that co-occur with the query word can be determined. However, such conventional approaches can employ significant computational resources. Moreover, computation of the actual values of the co-occurrence statistic for each word in the corpus of text documents can be time consuming.

Other conventional techniques involve either sampling or hashing the corpus of text documents in order to produce a smaller corpus over which to compute the co-occurrence statistics. For example, in a count-min sketch technique, word-document vectors from the sparse matrix can be hashed. In count-min sketch, elements of a word-document vector can be hashed to corresponding locations of a shorter, resultant vector, which is referred to as a sketch. Since the word-document vector is larger than the sketch, more than one element of the word-document vector is typically hashed to each location of the sketch. Elements of the word-document vector hashed to the same location in the sketch are summed. Moreover, inner products of sketches of the word-document vectors can be computed in the count-min sketch technique to produce upper bounds to the co-occurrence of pairs of words. Yet, the conventional approaches that employ sketching techniques produce estimates of the true pairwise co-occurrence statistics, which may be inaccurate.

### SUMMARY

Described herein are various technologies that pertain to computing top-K pairwise co-occurrence statistics using an upper bounding heuristic. Upper bound values of a co-occurrence statistic for items in a set can be computed based on a query item. The items and the query item are represented by respective portions of a tensor. Moreover, the items in the set can be sorted into an order. For instance, the items can be sorted such that the upper bound values of the co-occurrence statistic are descending in the order. An item from the order associated with a highest upper bound value can be selected, an actual value of the co-occurrence statistic can be computed for the selected item, the upper bound value for the selected item can be replaced with the actual value for the selected item, and the selected item can be repositioned in the order. The foregoing can be repeated while at least one of the top-K items in the order is associated with an upper bound value of the co-occurrence statistic, where K can be substantially any positive integer. When the top-K items in the order lack an item associated with an upper bound value (e.g., the top-K items in the order are associated with actual values of the co-occurrence statistic), the top-K items and actual values of the co-occurrence statistic for the top-K items can be outputted. In accordance with an example, the co-occurrence statistic can be an inner product between items.

In various embodiments, the upper bound values of the co-occurrence statistic can be computed for the items in the set using an upper bounding heuristic. Accordingly, a first function can be applied to a portion of the tensor that represents a query item. Moreover, a second function can be applied to respective portions of the tensor corresponding to the items in the set. An output of the first function and outputs of the second function can be respectively multiplied to compute the upper bound values of the co-occurrence statistic for the items in the set. Further, the first function can include a first norm and the second function can include a second norm. The first norm and the second norm can be selected to satisfy conditions of Holder's inequality. According to an example, the first norm can be a one-norm and the second norm can be an infinity-norm (or the first norm can be the infinity-norm and the second norm can be the one-norm). By way of another example, the first norm and the second norm can both be a two-norm. However, the claimed subject matter is not limited to the foregoing examples, and substantially any other norms are intended to fall within the scope of the hereto appended claims.

In yet other embodiments, a subset of items in the tensor can be compressed to generate a uniform upper bound value for the items in the subset. Further, the upper bound values of the co-occurrence statistic for the items in the set can be computed using a compressed tensor as outputted. The tensor can be compressed by applying one or more norms to elements in subblocks of the tensor. For instance, the subblocks of the tensor can include respective pluralities of the elements of the tensor (e.g., the subblocks of the tensor can include respective subsets of items in the tensor). Accordingly, individual counts for the elements of the tensor can be replaced by counts for the subblocks in the compressed tensor.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that identifies top-K items that co-occur with a query item, where K can be substantially any positive integer.

FIG. 2 illustrates an exemplary sparse matrix from which the top-K pairwise co-occurrence statistics can be computed.

FIGS. 3-4 illustrate exemplary computations of upper bound values of the co-occurrence statistic between items represented by portions of the sparse matrix of FIG. 2.

FIG. 5 illustrates an exemplary datacube from which the top-K pairwise co-occurrence statistics can be computed.

FIG. 6 illustrates an example of partial co-occurrence.

FIG. 7 illustrates an example of temporal co-occurrence.

FIG. 8 illustrates a functional block diagram of an exemplary system that compresses a tensor when identifying top-K items that co-occur with a query item.

FIG. 9 illustrates an exemplary compression that can be performed by the compression component of FIG. 8.

FIGS. 10-11 illustrate various mixed-norms being applied to a matrix.

FIG. 12 is a flow diagram that illustrates an exemplary methodology for computing top-K items that co-occur with a query item.

FIG. 13 is a flow diagram that illustrates an exemplary methodology for computing upper bound values of a co-occurrence statistic for items in a set based on a query item.

FIG. 14 illustrates an exemplary computing device.

### DETAILED DESCRIPTION

Various technologies pertaining to computing top-K pairwise co-occurrence statistics are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, top-K pairwise co-occurrence statistics can be computed using an upper bounding heuristic. The upper bounding heuristic can be employed to compute upper bound values of a co-occurrence statistic between a query item and disparate items, where the query item and the disparate items are represented by respective portions of a tensor. The upper bounding heuristic can be based on the Cauchy-Schwartz inequality. Upper bound values of the co-occurrence statistic can be computed for each of the disparate items. Moreover, the disparate items can be sorted into an order based on the upper bound values of the co-occurrence statistic. Further, actual values of the co-occurrence statistic can be computed for a subset of the disparate items while computation of actual values of the co-occurrence statistic for a remainder of the disparate items is inhibited. More particularly, an actual value of the co-occurrence statistic can be computed for the disparate item having a highest upper bound value. This actual value can be inserted back into the order, and the order can be resorted based on current values. This process may be repeated until the K highest values in the order are actual values of the co-occurrence statistic instead of upper bound values of the co-occurrence statistic. At this point, the top-K items that most frequently co-occur with the query item have been found. Normally, when finding the K items that most frequently co-occur with a query item, it may be necessary to compute the actual values of the co-occurrence statistic for all (or most) disparate items, and then sort the actual values in descending order. However, using the techniques set forth herein, it may be quicker to compute the upper bounds of the co-occurrence statistic than to compute the actual values of the co-occurrence statistic. Thus, the approach described herein can enable the top-K most frequently co-occurring items to more quickly be computed as compared to conventional techniques.

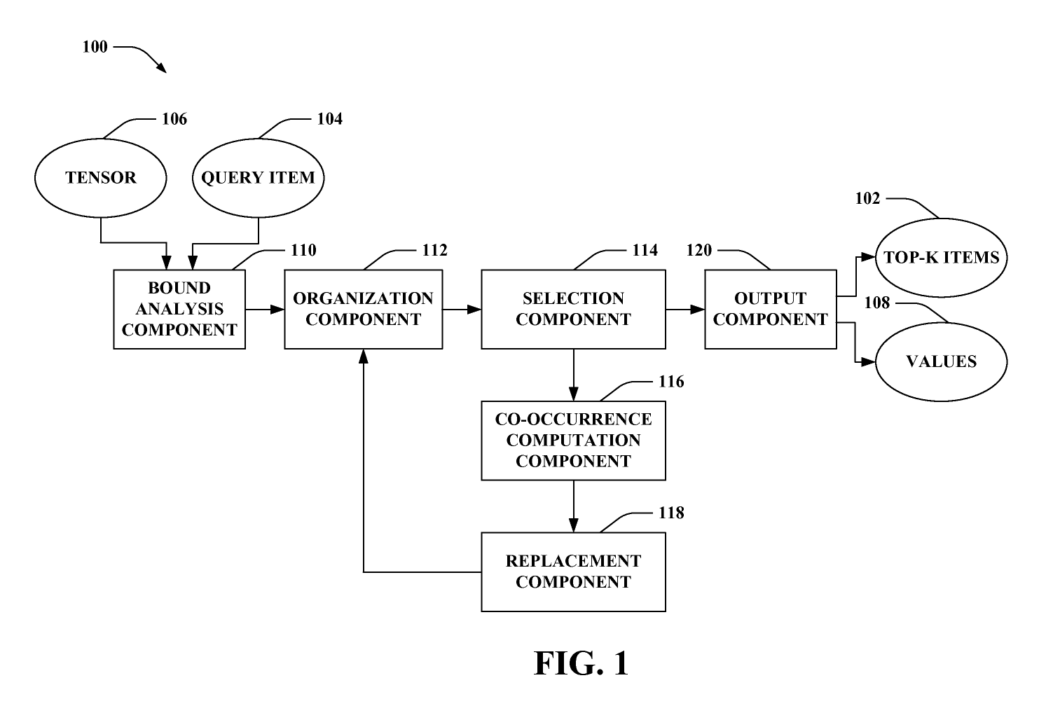

Referring now to the drawings, FIG. 1 illustrates a system 100 that identifies top-K items 102 that co-occur with a query item 104, where K can be substantially any positive integer. An item is represented by a portion of a tensor 106. Thus, the tensor 106 can represent a set of items, from which the top-K items 102 that co-occur with the query item 104 can be identified by the system 100.

For example, the tensor 106 can be a matrix (e.g., two-dimensional array), and the portion of the matrix that represents an item can be a column of the matrix or a row of the matrix. Further following the example where the tensor 106 is a matrix, the portion of the matrix that represents an item can be a part of a column of the matrix (e.g., a subset of elements in a column of the matrix) or a part of a row of the matrix (e.g., a subset of elements in a row of the matrix). Thus, pursuant to the example where the tensor 106 is a matrix, the item can be represented by a vector (e.g., one-dimensional array). By way of another example where the tensor 106 is a matrix, the item can be represented by a sub-matrix of the matrix. According to another example, the tensor 106 can be a datacube (e.g., three-dimensional array), and the portion of the datacube that represents an item can be a (three-dimensional) sub-cube, a (two-dimensional) matrix, or a (one-dimensional) vector. The term datacube refers to a three-dimensional array. Yet, it is also contemplated that the tensor 106 can be an array having more than three dimensions.

It is to be appreciated that a portion of the tensor 106 can represent substantially any type of item. In accordance with various examples, the item can be a word, a document, an internet protocol (IP) address, a user, or the like. The foregoing exemplary items can be represented as vectors of a matrix, matrices of a three-dimensional datacube, or the like. It is to be appreciated, however, that the claimed subject matter contemplates other items be represented by portions of the tensor 106. For instance, the tensor 106 can be an n-dimensional table, and the portion of the tensor 106 can be (n−1)-dimensional sub-tables; however, the claimed subject matter is not so limited.

The system 100 determines the top-K items 102 that co-occur with the query item 104. The top-K items 102 are identified by the system 100 from the set of items represented by the tensor 106. The top-K items 102 are items from the set that most frequently co-occur in the tensor 106 with the query item 104. Further, the system 100 can compute actual values 108 of a co-occurrence statistic for the top-K items 102. The co-occurrence statistic, for example, can be an inner product between the portions of the tensor 106 representing the items. The actual values 108 of the co-occurrence statistic for the top-K items 102 can be computed by the system 100 without computing actual values of the co-occurrence statistic for all (or most) of the items in the set of items represented by the tensor 106, which can improve computational efficiency as compared to techniques where actual values of the co-occurrence statistic are computed for all or most of the items in the set.

The system 100 includes a bound analysis component 110 that computes upper bound values of the co-occurrence statistic for the items in the set represented by respective portions of the tensor 106 based on the query item 104. Upper bound values of the co-occurrence statistic are respectively computed by the bound analysis component 110 between the query item 104 and each of the items in the set of items represented by the tensor 106. The bound analysis component 110 computes the upper bound values of the co-occurrence statistic using an upper bounding heuristic. Computing the upper bound values of the co-occurrence statistic employing the upper bounding heuristic is computationally faster than computing actual values of the co-occurrence statistic. Further, the upper bounding heuristic can support incremental updating. Thus, if the tensor 106 represents a corpus of documents, as additional documents are added to the corpus of documents, upper bound values of the co-occurrence statistic can be incrementally updated for words included in the additional documents.

The upper bounding heuristic can include two functions. The bound analysis component 110 can apply the first function to the portion of the tensor 106 that represents the query item 104. Further, the bound analysis component 110 can apply the second function to a given portion of the tensor 106 that represents a particular item in the set of items. Moreover, the bound analysis component 110 can multiply an output of the first function and an output of the second function to compute an upper bound value of the co-occurrence statistic for the particular item. The bound analysis component 110 can similarly apply the second function to other portions of the tensor 106 that represent the remainder of the items in the set, and respectively multiply the output of the first function and corresponding outputs of the second function to compute upper bound values of the co-occurrence statistic for the remainder of the items in the set.

According to an example, a portion of the tensor 106 that represents an item can be a vector (e.g., a one-dimensional array). Following this example, the first function applied by the bound analysis component 110 to a vector that represents the query item 104 can be a first norm of the vector, and the second function applied by the bound analysis component 110 to each of the other vectors that represent the remainder of the items in the set can be a second norm of the vector. It is contemplated that the first norm and the second norm can be the same or different. Pursuant to an illustration, the first norm can be a one-norm and the second norm can be an infinity-norm (or the first norm can be an infinity-norm and the second norm can be a one-norm). In accordance with another illustration, the first norm and the second norm can both be a two-norm. However, it is to be appreciated that the first norm and the second norm can be substantially any other norms that provide upper bounds for the vectors to which the norms are applied, and thus, are not limited to the foregoing illustrations. For example, the first norm and the second norm can be set to satisfy conditions of Holder's inequality; yet, the claimed subject matter is not so limited.

By way of another example, a portion of the tensor 106 that represents an item can be a matrix (e.g., a two-dimensional array). Accordingly, the first function applied by the bound analysis component 110 to a matrix that represents the query item 104 can include the first norm, and the second function applied by the bound analysis component 110 to each of the other matrices that represent the remainder of the items in the set can include the second norm. In accordance with an illustration, the bound analysis component 110 can apply the first norm to each column of the matrix that represents the query item 104 to compute an intermediate result, and apply the first norm or a different norm to the intermediate result. Moreover, the bound analysis component 110 can apply the second norm to each column of each of the other matrices that represent the remainder of the items in the set to compute respective intermediate results, and apply the second norm or a different norm to the respective intermediate results. By way of another illustration, the bound analysis component 110 can apply the first norm or a different norm to each row of the matrix that represents the query item 104 to compute an intermediate result, and apply the first norm to the intermediate result. Further, the bound analysis component 110 can apply the second norm or a different norm to each row of each of the other matrices that represent the remainder of the items in the set to compute respective intermediate results, and apply the second norm to the respective intermediate results. Again, it is to be appreciated that the first norm and the second norm can be set to satisfy conditions of Holder's inequality.

The system 100 can further include an organization component 112 that sorts the items from the set represented by the portions of the tensor 106 into an order. The organization component 112 can arrange the items from the set according to the upper bound values of the co-occurrence statistic generated by the bound analysis component 110. For example, the organization component 112 can sort the upper bound values of the co-occurrence statistic for the items in the set represented by the portions of the tensor 106 to be descending in the order. By way of example, the organization component 112 can place the arranged items in a heap; however, the claimed subject matter is not so limited.

Moreover, the system 100 includes a selection component 114, a co-occurrence computation component 116, and a replacement component 118. The selection component 114 selects an item from the order associated with a highest upper bound value of the co-occurrence statistic. Further, the co-occurrence computation component 116 computes an actual value of the co-occurrence statistic for the selected item from the order. Thus, the co-occurrence computation component 116 can determine the actual value of the co-occurrence statistic between the selected item and the query item 104. For instance, the co-occurrence computation component 116 can compute an inner product between the selected item from the order and the query item 104. Moreover, the replacement component 118 replaces the upper bound value of the co-occurrence statistic for the selected item with the actual value of the co-occurrence statistic for the selected item. The organization component 112 can thereafter reposition the selected item in the order based on the actual value of the co-occurrence statistic; however, it is to be appreciated that such repositioning of the selected item in the order need not be performed by the organization component 112. According to another example, the organization component 112 can remove one or more of the items from the set from consideration as possibly being within the top-K items based upon the actual value of the co-occurrence statistic for the selected item (e.g., if a top-one item is being identified, then any item having an upper bound value less than the actual value for the selected item can be removed).

Further, the selection component 114 can determine whether at least one of the top-K items in the order is associated with an upper bound value of the co-occurrence statistic. While the selection component 114 determines that at least one of the top-K items in the order is associated with an upper bound value of the co-occurrence statistic, the selection component 114 can select an item from the order associated with a highest upper bound value of the co-occurrence statistic, the co-occurrence computation component 116 can compute an actual value of the co-occurrence statistic for the selected item from the order, the replacement component 118 can replace the upper bound value of the co-occurrence statistic with the actual value of the co-occurrence statistic, and the organization component 112 can reposition the selected item in the order based on the actual value of the co-occurrence statistic. Thus, the co-occurrence computation component 116 can compute actual values of the co-occurrence statistic for a subset of the items in the set and inhibit computation of actual values of the co-occurrence statistic for a remainder of the items in the set. Moreover, when the selection component 114 determines that the top-K items in the order lack an item associated with an upper bound value of the co-occurrence statistic (e.g., the top-K items in the order are associated with actual values of the co-occurrence statistic), then an output component 120 can output the top-K items 102 and/or the actual values 108 of the co-occurrence statistic for the top-K items 102.

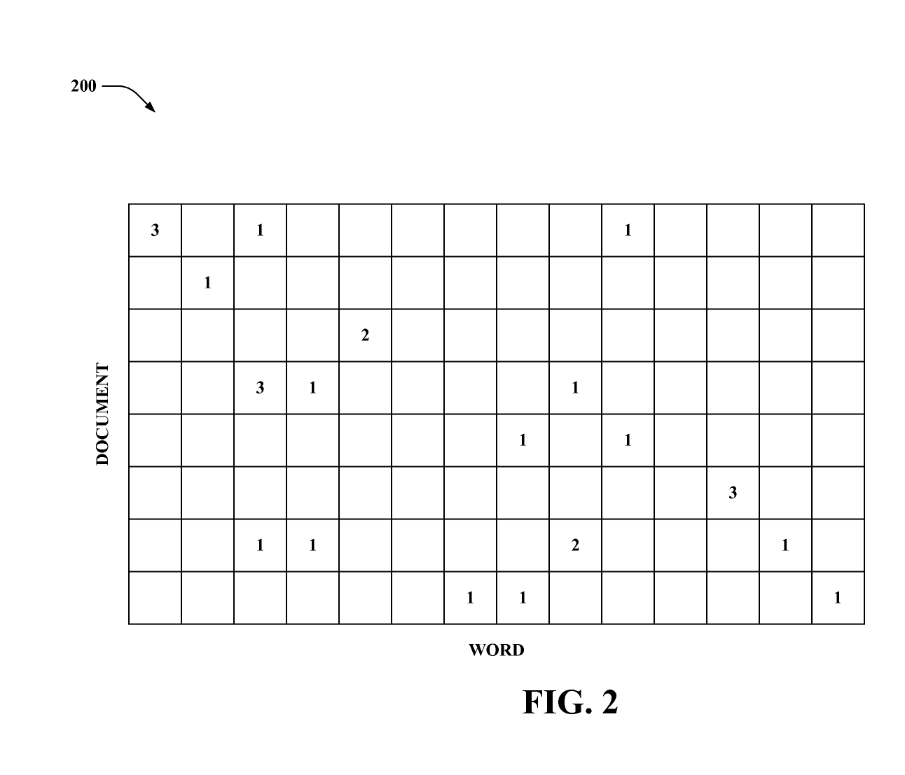

Now turning to FIG. 2, illustrated is an exemplary sparse matrix 200 from which the top-K pairwise co-occurrence statistics can be computed. A sparse matrix is a matrix populated primarily with zeros. The sparse matrix 200 can be the tensor 106 of FIG. 1; however, it is to be appreciated that the claimed subject matter is not so limited. The sparse matrix 200 includes M rows and N columns, where M and N can be substantially any positive integers. According to an example, the sparse matrix 200 and a transpose of the sparse matrix 200 can be stored in memory (not shown) of a computing device (not shown); yet, it is to be appreciated that the claimed subject matter is not so limited.

The sparse matrix 200 represents a corpus of documents. Accordingly, each row of the sparse matrix 200 represents a corresponding document, and each column of the sparse matrix 200 represents a corresponding word. As shown in the depicted illustration, a first document (e.g., represented by a first row of the sparse matrix 200) includes a first word (e.g., represented by a first column of the sparse matrix 200) three times, a third word (e.g., represented by a third column of the sparse matrix 200) one time, and a tenth word (e.g., represented by a tenth column of the sparse matrix 200) one time. Thus, elements of the sparse matrix 200 can have counts that correspond to frequencies of occurrence of words in documents. It is to be appreciated, however, that the sparse matrix 200 is presented as an example, and the claimed subject matter is not limited to such example. Further, it is contemplated that the techniques described herein can be applied to a binary sparse matrix. Accordingly, elements of a binary sparse matrix can be either a zero or a one as a function of whether the words occur in the documents (e.g., one for a document in which a word appears and zero for a document in which a word is omitted). In accordance with an example, elements of the sparse matrix 200 can be binarized by setting non-zero counts to 1; however, the claimed subject matter is not so limited.

In accordance with other examples, the sparse matrix 200 can represent other types of information. For example, the sparse matrix 200 can represent traffic going from one IP address to another IP address; hence, each row of the sparse matrix 200 can represent a corresponding source IP address and each column of the sparse matrix 200 can represent a corresponding target IP address. Pursuant to another example, the sparse matrix 200 can represent a user query log. Following this example, each row of the sparse matrix 200 can represent a corresponding user and each column can represent a corresponding word. Yet, the claimed subject matter is not limited to the foregoing examples.

Again, reference is made to FIG. 1. According to an example, the system 100 can determine top-K words (e.g., the top-K items 102) that co-occur with a query word (e.g., the query item 104) in a sparse matrix (e.g., the tensor 106, the sparse matrix 200 of FIG. 2) that represents a corpus of documents, D. Columns of the sparse matrix can represent a set of items, namely, a set of words. For instance, x and y can represent two word vectors (e.g., two columns) of the sparse matrix. As used herein, x and y can also denote the words whose statistics they represent. Hence, xᵢ=3 means that the word represented by x appears three times in the i-th document, and yⱼ=5 means that the word represented by y appears five times in the j-th document.

Moreover, the co-occurrence statistic computed by the system 100 can be an inner product between portions of the sparse matrix. For example, an inner product between x and y can be computed herein, where the inner product counts the number of times the two words represented by x and y co-occur in the same document (e.g., same row of the sparse matrix). The inner product between x and y is x^{T}y, where x^{T} is the transpose of x.

The word x from the corpus of documents D can be the query word inputted to the system 100. The system 100 can determine the top-K words that co-occur most frequently with the word x in the corpus of documents D. Thus, the output component 120 can output a list of the top-K words, Y={y⁽¹⁾, y⁽²⁾, . . . , y^{(K)}} (e.g., the top-K items 102). Further, the system 100 can generate actual co-occurrence counts for each of the top-K words. Hence, the output component 120 can output actual values of the inner products for the top-K words, {x^{T}y⁽¹⁾, x^{T}y⁽²⁾, . . . , x^{T}y^{(K)}} (e.g., the actual values 108).

More particularly, the sparse matrix that represents the corpus of documents D and the query word x can be provided to the bound analysis component 110. For each word w represented by a corresponding column of the sparse matrix (other than the query word x), the bound analysis component 110 can construct upper bound values for the inner product, U(x, w), rather than actual values of the inner product, x^{T}w. The bound analysis component 110 can compute the upper bound values for the inner product based on the upper bounding heuristic. The upper bounding heuristic includes two functions, f(x) and g(w), used to construct the upper bound value for the inner product, such that x^{T}w≦f(x)g(w) for all word vectors x and w.

The bound analysis component 110 can compute upper bound values for each word w, U(x, w)=f(x)g(w). Further, the organization component 112 can sort the words w according to descending U(x, w) into an order. For example, the organization component 112 can place the sorted words in a heap. The selection component 114 can choose a first word, w⁽¹⁾, as sorted by the organization component 112; the first word, w⁽¹⁾, for example, can be a first word in the heap. Moreover, the selection component 114 can determine whether the first word, w⁽¹⁾, is associated with an upper bound value of the inner product, U(x, w⁽¹⁾), computed by the bound analysis component 110 or an actual value of the inner product. If the selection component 114 determines that the first word, w⁽¹⁾, is associated with an upper bound value of the inner product, then the co-occurrence computation component 116 can compute an actual value of the inner product between the first word, w⁽¹⁾, and the query word, x, which is represented as x^{T}w⁽¹⁾. The replacement component 118 replaces the upper bound value of the inner product for the first word with the actual value of the inner product for the first word. The replacement component 118, for example, can place the actual value of the inner product for the first word back into the heap, which can then be resorted by the organization component 112 to place the first word at an appropriate position within the order according to descending U(x, w) and x^{T}w. Alternatively, if the selection component 114 determines that the first word, w⁽¹⁾, is associated with an actual value of the inner product, then the selection component 114 can add the first word, w⁽¹⁾, to the list of top-K words, Y.

Moreover, the selection component 114 can determine whether the list of top-K words, Y, includes K words or less than K words. If the list of top-K words, Y, includes K words, then the output component 120 can return the list of top-K words, Y. Alternatively, if the list of top-K words, Y, includes less than K words, then the selection component 114 can choose a next word (e.g., a first word in the order previously not included in the list of top-K words) as sorted by the organization component 112, and the foregoing can be repeated until the selection component 114 determines that the list of top-K words, Y, includes K words.

Computation of the upper bound values of the inner product by the bound analysis component 110 can be faster than computation of the actual inner product by the co-occurrence computation component 116. Moreover, the organization component 112 can rank the words represented by columns of the sparse matrix by the corresponding upper bound values, and the selection component 114 can identify a subset of the words with large enough upper bound values that may possibly be in the top-K words. Further, the co-occurrence computation component 116 can compute the actual values of the inner product for the subset of the words identified by the selection component 114 as opposed to all or most of the words represented by the columns of the sparse matrix; thus, computation of actual values of the inner product for remaining words in the set (e.g., other than the subset of words identified by the selection component 114) can be inhibited.

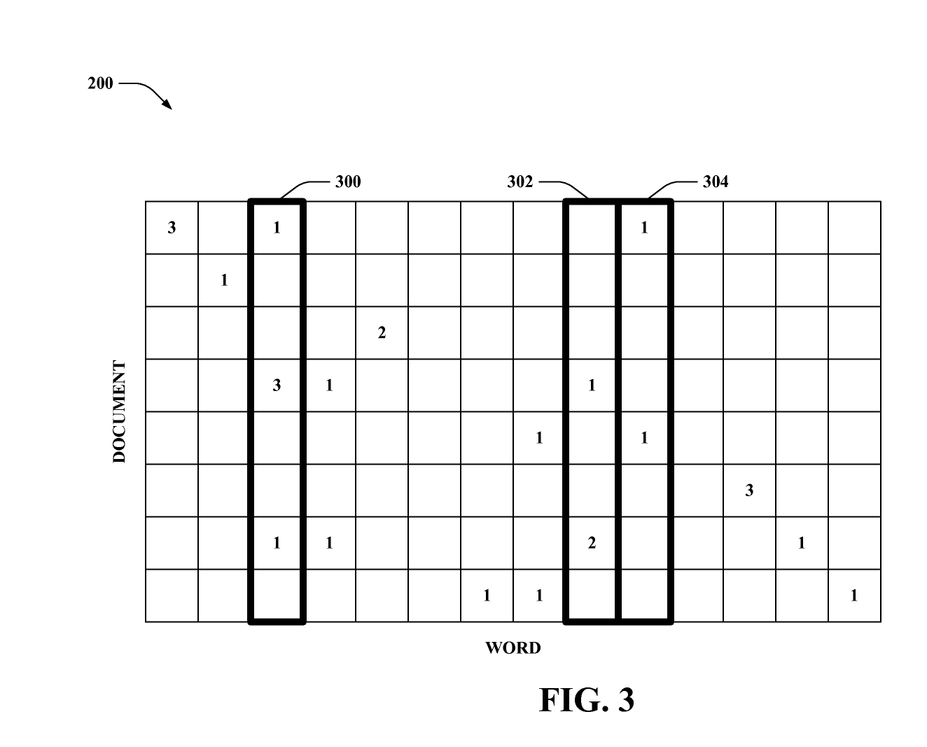

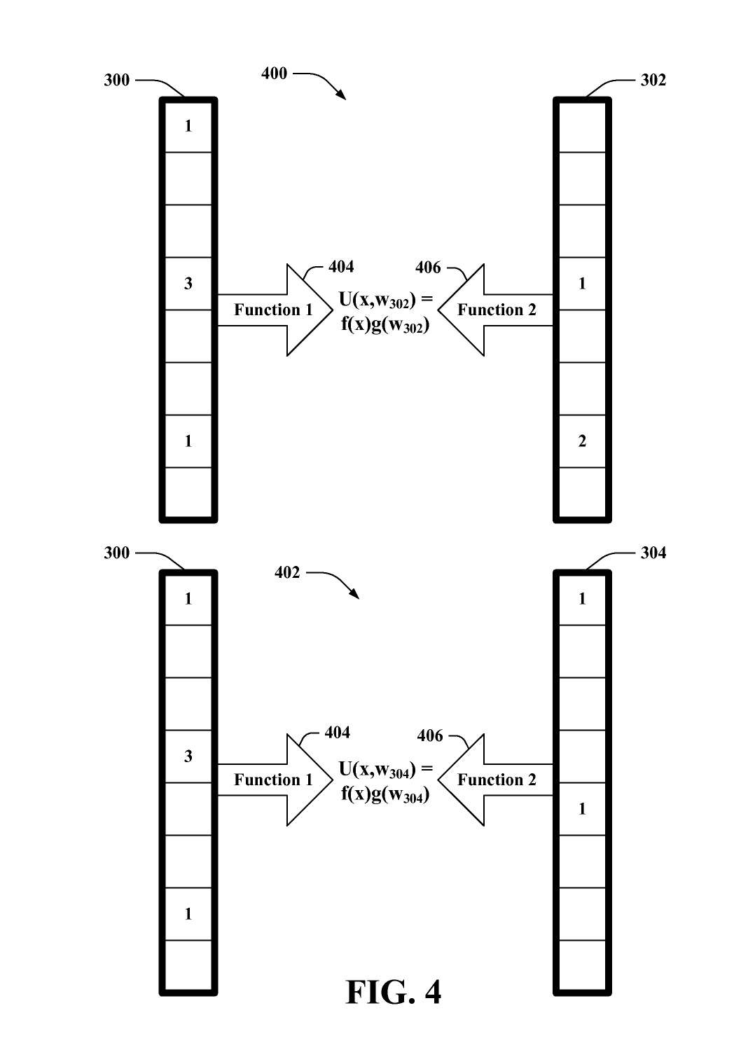

With reference to FIGS. 3-4, illustrated are exemplary computations of upper bound values of the co-occurrence statistic between items represented by portions of the sparse matrix 200 of FIG. 2 (e.g., the portions of the sparse matrix 200 are columns of the sparse matrix 200). As depicted in FIG. 3, column 300 of the sparse matrix can represent the query word. Moreover, column 302 and column 304 can represent disparate words for which respective upper bound values of the co-occurrence statistic can be computed. The column 300 can be represented as x, the column 302 can be represented as w₃₀₂, and the column can be represented as w₃₀₄. By way of illustration, the column 300 can be a count vector for “hello”, the column 302 can be a count vector for “world”, and the column 304 can be a count vector for “today”; yet, it is to be appreciated that the claimed subject matter is not so limited. Although not shown, it is to be appreciated that upper bound values of the co-occurrence statistic can similarly be computed for words represented by the remainder of the columns of the sparse matrix 200.

Now turning to FIG. 4, illustrated is a computation 400 of an upper bound value of the co-occurrence statistic for the column 302 from FIG. 3 and a computation 402 of an upper bound value of the co-occurrence statistic for the column 304 from FIG. 3. The computation 400 and the computation 402 employ the upper bounding heuristic. In the computation 400 and the computation 402, a first function 404 is applied to the column 300 to compute an output (e.g., f(x)). Moreover, in the computation 400, a second function 406 is applied to the column 302 to compute an output (e.g., g(w₃₀₂)). Similarly in the computation 402, the second function 406 is applied to the column 304 to compute an output (e.g., g(w₃₀₄)). In the computation 400, the output of the first function is multiplied by the output of the second function to generate an upper bound value of the co-occurrence statistic between the column 300 and the column 302, U(x, w₃₀₂). Similarly, in the computation 402, the output of the first function is multiplied by the output of the second function to generate an upper bound value of the co-occurrence statistic between the column 300 and the column 304, U(x, w₃₀₄).

According to an example, the upper bounding heuristic can be a mixed norm upper bounding heuristic with norms selected to satisfy conditions of Holder's inequality. For any a, b ε [symbol] ^{N}, and any p, q such that 1≦p,q≦∞ an

$$\frac{1}{p} + \frac{1}{q} = 1 ,$$

it follows that |a^{T}b|≦∥a∥ₚ∥b∥_{q}. Thus, an absolute value of an actual value of an inner product between vector a and vector b can be less than or equal to a product of a p-norm of vector a times a q-norm of vector b, where p and q can be defined as set forth above.

Holder's inequality gives a family of norms that can be applied as part of the upper bounding heuristic (e.g., it is valid for any p and q satisfying 1≦p,q≦∞ and

$$\frac{1}{p} + \frac{1}{q} = 1 ) .$$

Examples include p=q=2; p=1 and q=∞; and p=∞ and q=1.

An actual value of an inner product (e.g., actual value of a co-occurrence statistic) between the column 300, x, and one of the other columns of the sparse matrix 200, w, (e.g., the column 302 or the column 304) can be computed as x^{T}w=Σᵢxᵢwᵢ. For instance, if x and w are both binary vectors, xᵢ=1 if and only if the word represented by x (e.g., “hello”) appears in document i, wᵢ=1 if and only if the word represented by w (e.g., “world”) appears in document i, and xᵢwᵢ=1 if and only if both the word represented by x and the word represented by w appears in document i. Hence, the foregoing summation can provide a total co-occurrence count across documents in the document corpus. According to an example, let x=(x₁, x₂, x₃) and let w=(w₁, w₂, w₃). Following this example, the actual value of the inner product between x and w is x₁w₁+x₂w₂+x₃w₃.

Rather than computing the actual value of the inner product between x and w, an upper bound value of the inner product can be computed. This upper bound value can be based on Holder's inequality, using the p and q-norms of x and w (e.g., the p-norm can be applied to x and the q-norm can be applied to w, or vice versa). The p-norm of x can be represented as ∥x∥ₚ=(Σᵢ|xᵢ|^{p})^{1/p} and the q-norm of w can be represented as ∥w∥_{q}=(Σᵢ|wᵢ|^{q})^{1/q}. According to an example, the first function 404 can be a one-norm and the second function 406 can be an infinity-norm. The one-norm of x is defined as ∥x∥₁=Σᵢ₌₁ⁿ|xᵢ|=|x₁|+|x₂|+ . . . +|xₙ|; thus, the one-norm sums the absolute value of elements of x. Further, the infinity-norm of w is defined as ∥w∥_{∞}=maxᵢ|wᵢ|. In accordance with this example, x^{T}w≦∥x∥₁∥w∥_{∞}, assuming all elements of x and w are non-negative. By way of another example, the first function 404 and the second function 406 can both be a two-norm. However, it is to be appreciated that other norms, with p and q as set forth above, are intended to fall within the scope of the hereto appended claims.

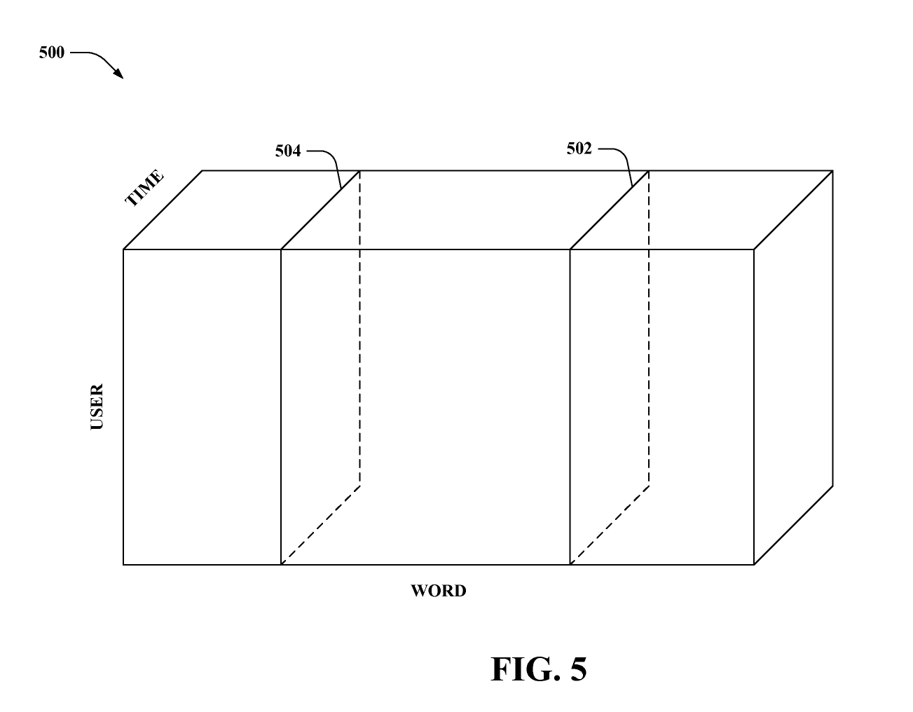

Referring to FIG. 5, illustrated is an exemplary datacube 500 from which the top-K pairwise co-occurrence statistics can be computed. The datacube 500 can be the tensor 106 of FIG. 1; however, it is to be appreciated that the claimed subject matter is not so limited. The datacube 500 can represent user query words (e.g., in a search engine) over time; yet, it is to be appreciated that the claimed subject matter is not limited to the illustrated example. The datacube 500 includes a height of A elements (e.g., user axis), a width of B elements (e.g., word axis), and a depth of C elements (e.g., time axis), where A, B, and C can be substantially any positive integers. Similar to the sparse matrix 200 of FIG. 2, the datacube 500 can be a sparse datacube.

According to an example, the query item 104 of FIG. 1 can be a particular word represented by a portion of the datacube 500 such as a word represented by a matrix 502. For instance, it can be desired to identify the top-K words that co-occur with the query word represented by the matrix 502. The matrix 502 represents the query word across users and across time. Moreover, other matrices across users and across time such as, for instance, a matrix 504, represent a remainder of words in a set represented by the datacube 500, where the top-K words that co-occur with the query word represented by the matrix 502 can be identified from the set.

Similar to above, upper bound values of the inner product between the query word and each of the remaining words in the set represented by the datacube 500 can be computed (e.g., by the bound analysis component 110 of FIG. 1). For instance, a first function can be applied to the matrix 502 that represents the query word, and a second function can be applied to other matrices of the datacube 500 that represent the remaining words in the set, such as the matrix 504. Moreover, the output of the first function and the output of the second function can be multiplied for each of the other matrices of the datacube 500 corresponding to the remaining words in the set to generate respective upper bound values of the inner product. Thereafter, the upper bound values can be organized and employed as set forth in connection with FIG. 1 to output the top-K words that co-occur with the query word and/or actual values of the inner product for the top-K words.

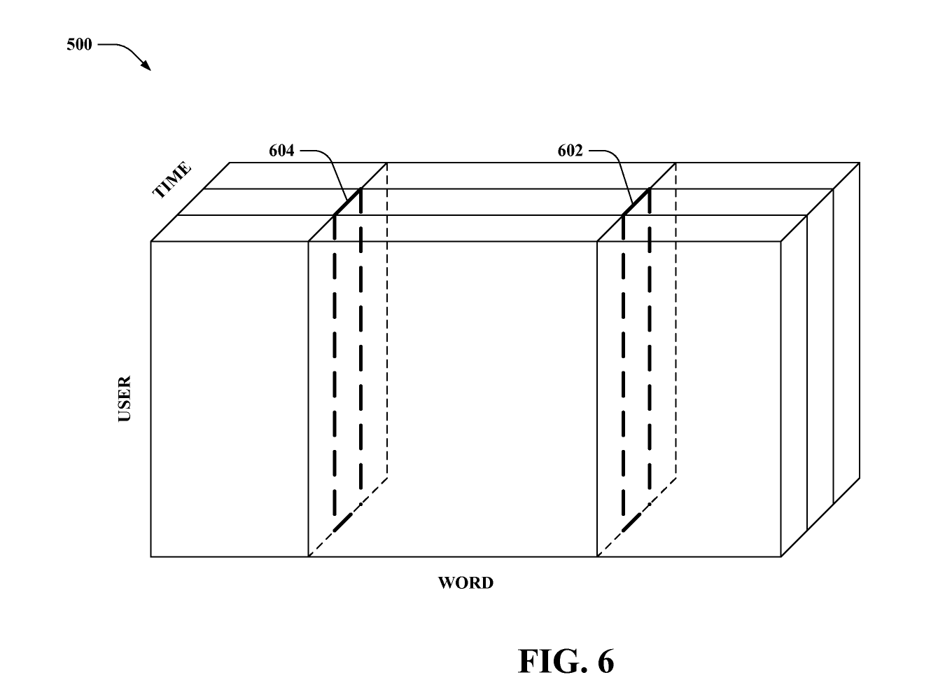

FIG. 6 illustrates an example of partial co-occurrence. FIG. 6 again depicts the exemplary datacube 500 of FIG. 5. Rather than the query item 104 of FIG. 1 being a particular word across users and across time, as represented by the matrix 502 of FIG. 5, the query item 104 can be a particular word across users during a given time period (e.g., during a particular year such as 2010, etc.), represented as a matrix 602. Accordingly, it can be desired to identify the top-K words that co-occur with the query word during the given time period. Moreover, other matrices across users and during the given time period such as, for instance, a matrix 604, represent a remainder of words in a set represented by the datacube 500, where the top-K words that co-occur with the query word during the given time period represented by the matrix 602 can be identified from the set.

Similar to the foregoing description, upper bound values of the inner product can be computed by applying the first function to the matrix 602 that represents the query word during the given time period, and applying the second function to the other matrices that represent the remaining words in the set during the given time period, such as the matrix 604. Further, the output of the first function and the output of the second function can be multiplied for each of the other matrices of the datacube 500 corresponding to the remaining words in the set during the given time period to generate respective upper bound values of the inner product. Thereafter, the upper bound values can be organized and employed as set forth in connection with FIG. 1 to output the top-K words that co-occur with the query word during the given time period and/or actual values of the inner product for the top-K words during the given time period.

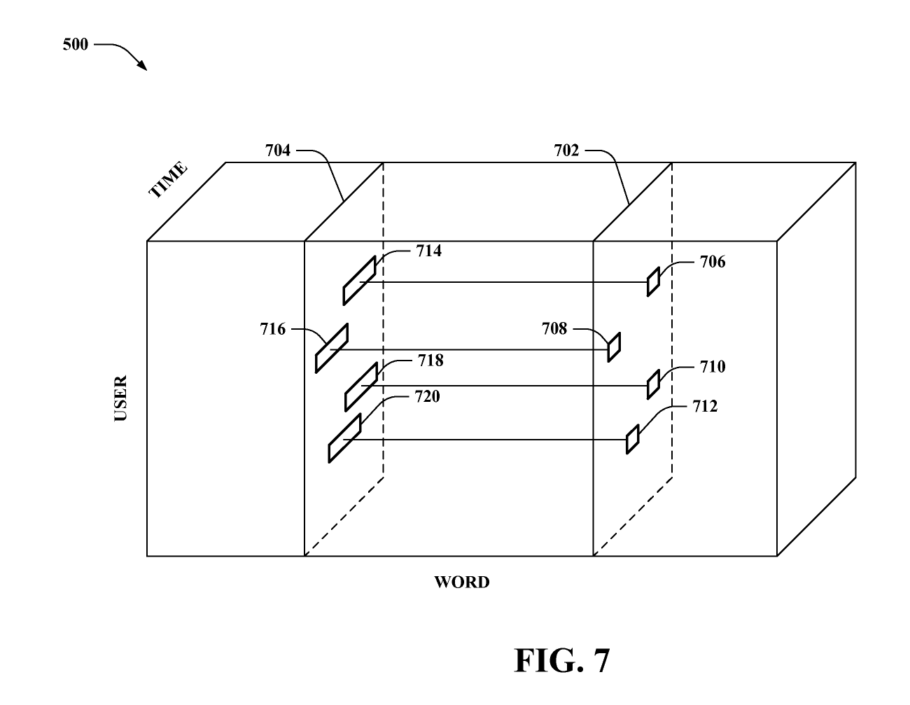

FIG. 7 illustrates an example of temporal co-occurrence. According to an example, it can be desired to identify the top-K words that co-occur within a particular length of time of an occurrence of a query word. FIG. 7 again shows the exemplary datacube 500 of FIG. 5. The query word can be represented by a matrix 702, while other words represented by the datacube 500 can be represented by other matrices, such as a matrix 704.

In the illustrated example, the query word is shown to have occurred four times (e.g., element 706, element 708, element 710, and element 712 which are collectively referred to as elements 706-712). By way of example, it can be desired to identify the top-K words that co-occur within a week of an occurrence of the query word. A disparate word, such as a word represented by the matrix 704, can be considered to co-occur with the query word based on occurrences of the disparate word within a week of an occurrence of the query word. The foregoing is shown in FIG. 7 as projections of the elements 706-712 on the matrix 704 that are expanded outwards in time (e.g., projection 714, projection 716, projection 718, and projection 720 which are collectively referred to as projections 714-720). Thus, occurrence(s) of the disparate word within the projection 714 can be considered to be a co-occurrence with the occurrence of the query word represented by element 706, and so forth. Similar to above, the upper bounding heuristic can be employed when identifying the top-K temporal co-occurring words.

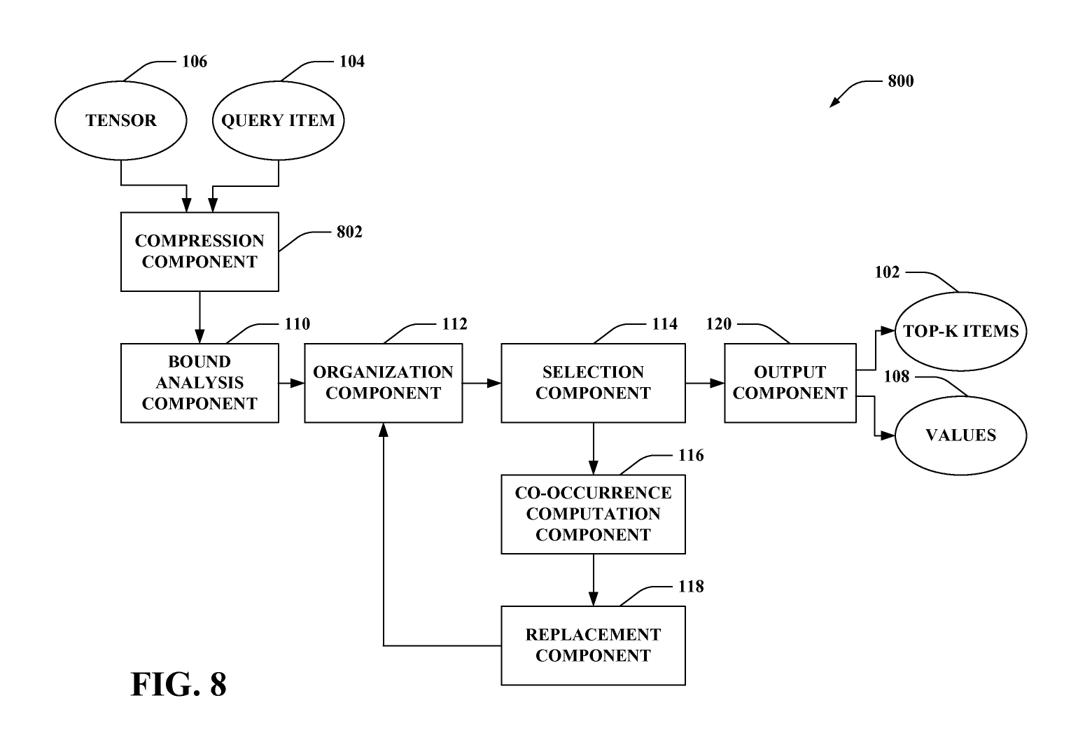

With reference to FIG. 8, illustrated is an exemplary system 800 that compresses the tensor 106 when identifying the top-K items 102 that co-occur with the query item 104. Similar to the system 100 of FIG. 1, the system 800 includes the bound analysis component 110, the organization component 112, the selection component 114, the co-occurrence computation component 116, the replacement component 118, and the output component 120. Moreover, the system 800 includes a compression component 802 that compresses the tensor 106 prior to the bound analysis component 110 computing the upper bound values of the co-occurrence statistic for the items in the set represented by respective portions of the tensor 106. Thus, the bound analysis component 110 can generate upper bound values of the co-occurrence statistic using the compressed tensor generated by the compression component 802. By compressing the tensor 106 with the compression component 802, the bound analysis component 110 can calculate a uniform upper bound value of the co-occurrence statistic for portions of the tensor 106 that are combined in a compressed tensor (e.g., a uniform upper bound value for a group of co-occurrence statistics can be outputted by the bound analysis component 110 using the compressed tensor from the compression component 802).

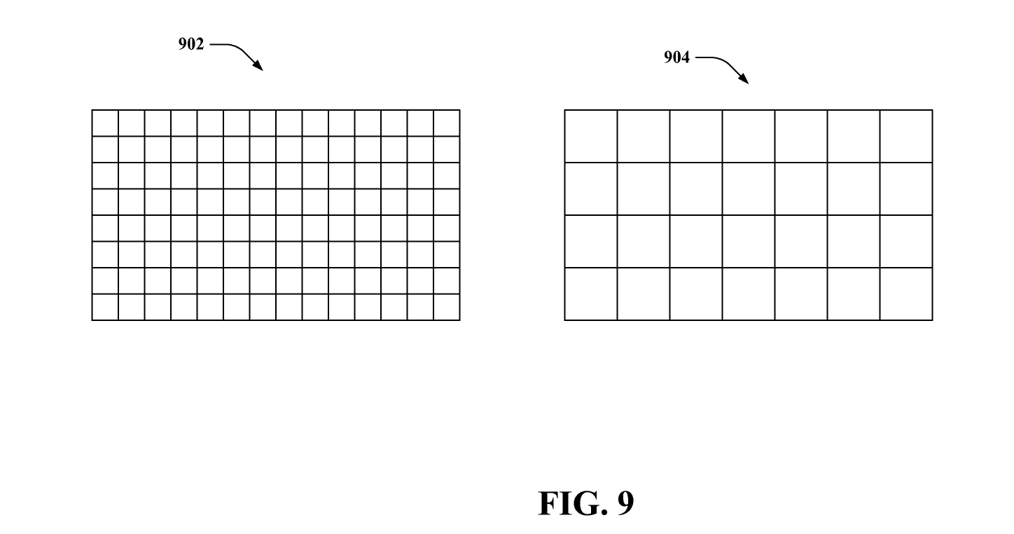

FIG. 9 illustrates an exemplary compression that can be performed by the compression component 802 of FIG. 8. According to the depicted example of FIG. 9, the tensor 106 inputted to the compression component 802 of FIG. 8 can be a matrix 902 with 8 rows and 14 columns. For instance, the rows of the matrix 902 can correspond to documents and the columns can correspond to words; however, it is to be appreciated that the claimed subject matter is not so limited. The compression component 802 can compress rows and columns of the matrix 902 to generate a compressed matrix 904 with 4 rows and 7 columns. Thus, the compression component 802 can combine elements in a first two rows and a first two columns, elements in a second two rows and the first two columns, and so forth. Thus, each subblock of the matrix 902 can be a sub-matrix that includes two rows and two columns, and norms can be applied to each of the subblocks of the matrix 902 as described below. Accordingly, the compressed matrix 904 includes fewer elements, each of which is an upper bound in some sense of a corresponding subblock of the matrix 902. It is to be appreciated, however, that the claimed subject matter is not limited to the depicted example in FIG. 9. Further, it is contemplated that the compression component 802 can employ substantially any mapping between elements of the tensor 106 and subblocks of the tensor 106.

Again, reference is made to FIG. 8. According to another example, the tensor 106 can be a datacube. The compression component 802 can map elements of the datacube to one, two, or three dimensional subblocks. Moreover, the compression component 802 can combine elements of the datacube that map to a subblock using one or more norms. The compression component 802 can employ substantially any norm(s) so long as the count for a given subblock is an upper bound on each element mapped to that given subblock.

The compression component 802 can combine elements of the tensor 106 to output a compressed tensor upon which the bound analysis component 110 can compute the upper bound values of the co-occurrence statistic. The compression component 802 can combine elements by applying one or more norms to elements in subblocks of the tensor 106, where each subblock includes a respective plurality of elements of the tensor 106. Hence, a subblock of the tensor 106 can be represented as an element in the compressed tensor. Each element in the compressed tensor can be an upper bound on the column or row norms of the subblocks of the uncompressed tensor 106.

The compression component 802 enables the bound analysis component 110 to compute a uniform upper bound value for a group of co-occurrence statistics. According to an example, the compression component 802 can compress subblocks of the matrix 902 of FIG. 9 (e.g., the tensor 106 can be the matrix 902). By way of an example, when the sparse matrix 902 represents a document-term matrix, the bound analysis component 110 can generate a uniform upper bound U_{uniform} using the compressed subblocks such that U_{uniform}>x^{T}wᵢ, where x is the query word and wᵢ is one of the words in the compressed subblock.

Following the foregoing example, let Aε [symbol] ₊^{m,n} be a matrix with M rows and N columns whose elements are non-negative real numbers. A may be taken to be a subblock of the matrix 902 in FIG. 9. Accordingly, a mixed-norm of A can be computed that can serve as an upper bound of the norms of the columns (or rows) of A. Let aᵢⱼ denote the (i,j)-th element of A (e.g., the element at the i-th row and the j-th column) A u-v mixed norm of the matrix A can be defined as a function L_{u,v}^{c}(A), where u≧1, v≧1, as follows:

$${L}_{u , v}^{c} ( A ) = {( {\sum }_{j} {( {\sum }_{i} {a}_{ij}^{u} )}^{v / u} )}^{1 / v}$$

Thus, L_{u,v}^{c}(A) computes the u-norm of each column, then computes the v-norm of the result. Also, the associated mixed-norm L_{v,u}^{r}(A) that takes the row-norm first, then the norm of the resulting column can be defined as follows:

$${L}_{v , u}^{r} ( A ) = {( {\sum }_{i} {( {\sum }_{j} {a}_{ij}^{v} )}^{u / v} )}^{1 / u}$$

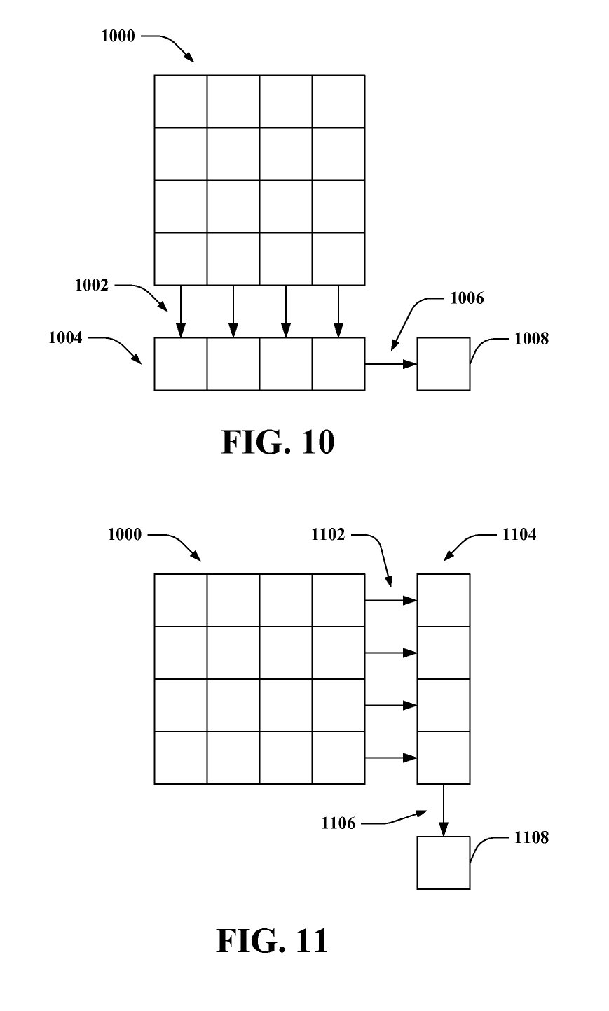

FIGS. 10-11 illustrate various mixed-norms being applied to a matrix 1000. FIG. 10 depicts the L_{u,v}^{c} mixed-norm being applied to the matrix 1000, and FIG. 11 depicts the L_{v,u}^{c} mixed-norm being applied to the matrix 1000. The matrix 1000 can be represented as matrix block A. In FIG. 10, the u-norm 1002 can be applied to the columns of the matrix 1000 to provide a resulting row 1004. Thereafter, the v-norm 1006 can be applied to the resulting row 1004 to generate an output 1008. In FIG. 11, the v-norm 1102 can be applied to the rows of the matrix 1000 to provide a resulting column 1104. Thereafter, the u-norm 1106 can be applied to the resulting column 1104 to generate an output 1108.

Again, reference is made to FIG. 8. Both L^{r} and L^{c} are upper bounds of the individual column norms of A (e.g., the ordering in which the matrix is compressed does not affect the fact that the resulting scalar is an upper bound of the norm of any column) Further, both L^{r} and L^{c} are upper bounds of the individual row norms of A.

Pursuant to an illustration, let A be a matrix of column vectors of candidate words wⱼ. Let A₁, . . . , Aₖ be the subblocks to be compressed using the above defined mixed-norms. Let x represent the query word, and x₁, . . . , xₖ represent the subblocks of x. Using the mixed-norm bounds on the subblocks of A, and choosing p, q satisfying the conditions of Holder's inequality, the following upper bounds on the inner product of x with any column wⱼ of A can be computed.

$${x}^{T} {w}_{j} \leq {\sum }_{i = 1}^{k} {‖ {x}_{i} ‖}_{p} {L}_{u , q}^{c} ( {A}_{i} )$$

$${x}^{T} {w}_{j} \leq {\sum }_{i = 1}^{k} {‖ {x}_{i} ‖}_{p} {L}_{q , u}^{r} ( {A}_{i} )$$

In view of the foregoing, the bound analysis component 110 can use the lesser of the two upper bounds above to bound the inner product between x and wⱼ. Furthermore, the bound analysis component 110 can compute the upper bound for multiple wⱼ's together.

In accordance with another example, organization of the compression of the tensor 106 performed by the compression component 802 can be based on a type of query being performed by the system 800. For instance, the compression component 802 can compress a time dimension to support queries of desired time granularities (e.g., compress a time dimension from days to weeks to support a query pertaining to co-occurrence within 5 weeks, etc.).

In various embodiments, the co-occurrence component 116 can compute actual values of the co-occurrence statistic for a selected item using the tensor 106 (e.g., the uncompressed tensor). In other embodiments, the co-occurrence component 116 can compute actual values of the co-occurrence statistic for a selected item using the compressed tensor. In yet other embodiments, both the compressed tensor and the tensor 106 can be used by the co-occurrence component 116 to compute actual values of the co-occurrence statistic for a selected item.

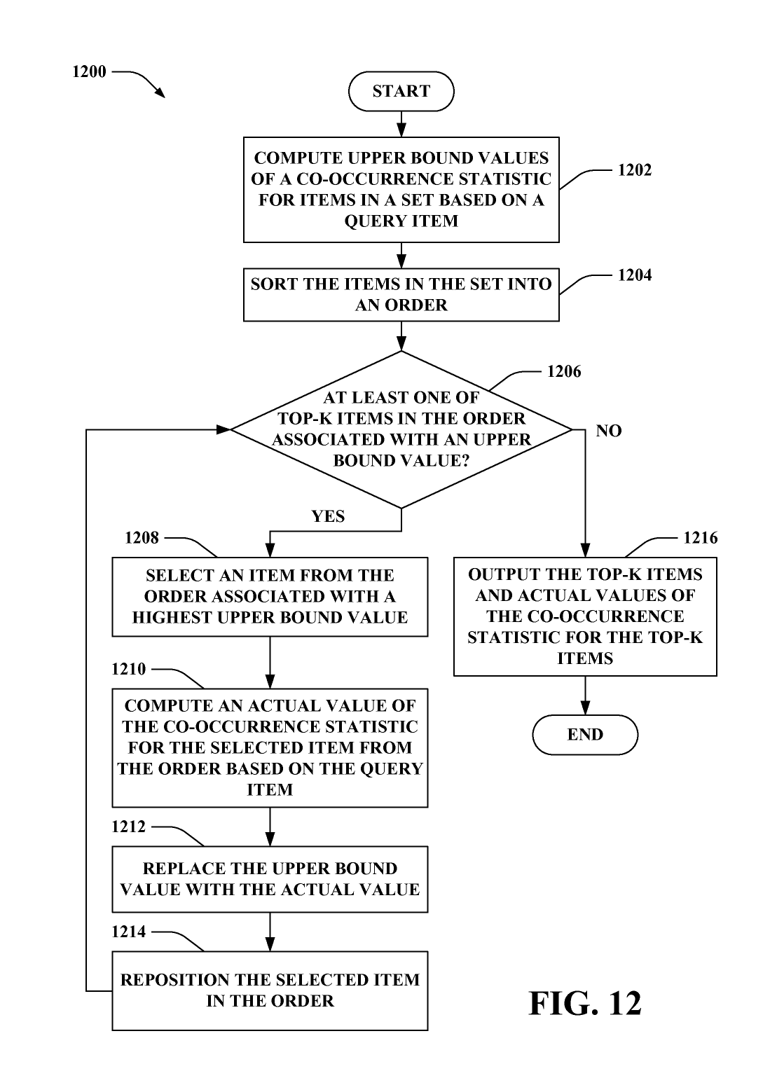

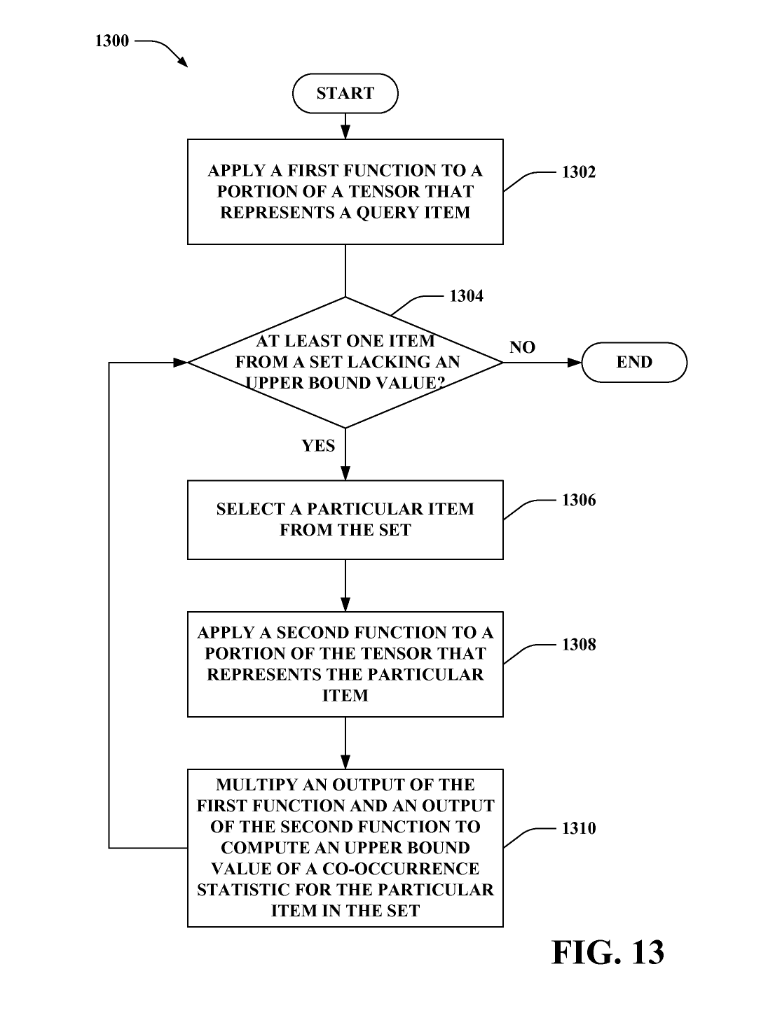

FIGS. 12-13 illustrate exemplary methodologies relating to computing top-K pairwise co-occurrence statistics. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 12 illustrates a methodology 1200 for computing top-K items that co-occur with a query item. At 1202, upper bound values of a co-occurrence statistic for items in a set can be computed based on a query item. The upper bound values can be computed based on an upper bounding heuristic. According to an example, the co-occurrence statistic can be an inner product between items. At 1204, the items in the set can be sorted into an order. For instance, the upper bound values of the co-occurrence statistics for the items in the set can be sorted to be descending in the order.

At 1206, whether at least one of a top-K items in the order is associated with an upper bound value of the co-occurrence statistic can be determined. For instance, K can be substantially any positive integer. When at least one of the top-K items in the order is determined to be associated with an upper bound value of the co-occurrence statistic at 1206, the methodology 1200 continues to 1208. At 1208, an item from the order associated with a highest upper bound value of the co-occurrence statistic can be selected. At 1210, an actual value of the co-occurrence statistic for the selected item from the order can be computed based on the query item. At 1212, the upper bound value of the co-occurrence statistic for the selected item can be replaced with the actual value of the co-occurrence statistic for the selected item. At 1214, the selected item can be repositioned in the order based on the actual value of the co-occurrence statistic. The methodology 1200 can then return to 1206. Moreover, when the top-K items in the order are determined to lack an item associated with an upper bound value of the co-occurrence statistic at 1206, the methodology 1200 can continue to 1216. At 1216, the top-K items and actual values of the co-occurrence statistic for the top-K items can be outputted.

Now turning to FIG. 13, illustrated is a methodology 1300 for computing upper bound values of a co-occurrence statistic for items in a set based on a query item. At 1302, a first function can be applied to a portion of a tensor that represents the query item. At 1304, a determination can be made concerning whether at least one item from a set is lacking an associated upper bound value of the co-occurrence statistic. When it is determined that at least one item from the set is lacking an associated upper bound value of the co-occurrence statistic at 1304, then the methodology 1300 can continue to 1306. At 1306, a particular item from the set can be selected. The particular item can be lacking an associated upper bound value of the co-occurrence statistic. At 1308, a second function can be applied to a portion of the tensor that represents the particular item. At 1310, an output of the first function and an output of the second function can be multiplied to compute an upper bound value of the co-occurrence statistic for the particular item in the set. Thereafter, the methodology 1300 returns to 1304. Further, when it is determined that no item from the set is lacking an associated upper bound value of the co-occurrence statistic at 1304, then the methodology 1300 ends.

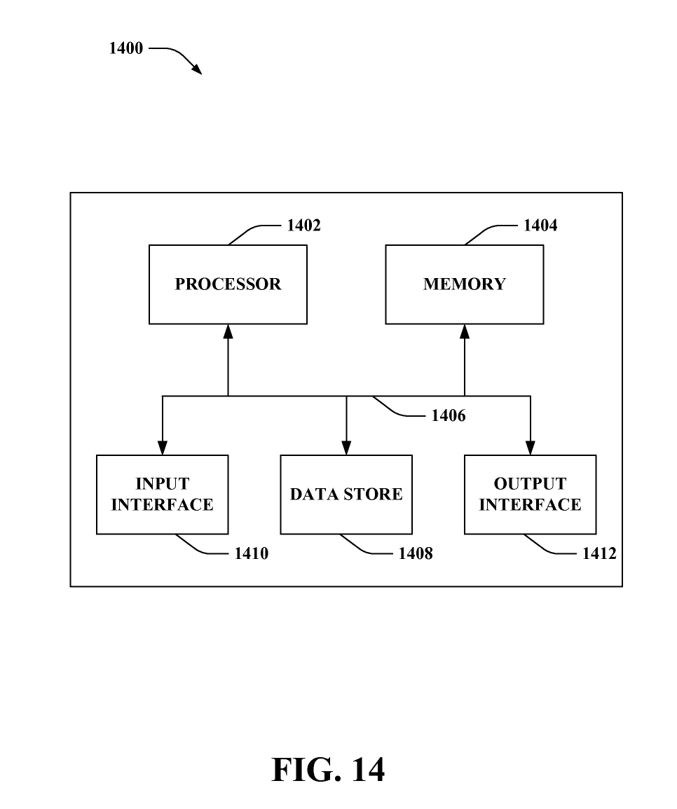

Referring now to FIG. 14, a high-level illustration of an exemplary computing device 1400 that can be used in accordance with the systems and methodologies disclosed herein is illustrated. For instance, the computing device 1400 may be used in a system that computes top-K items that co-occur with a query item and/or actual values of a co-occurrence statistic for the top-K items. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store a tensor, a transpose of the tensor, an order of items in a set, upper bound values of a co-occurrence statistic, actual values of the co-occurrence statistic, and so forth.

The computing device 1400 additionally includes a data store 1408 that is accessible by the processor 1402 by way of the system bus 1406. The data store 1408 may include executable instructions, a tensor, a transpose of the tensor, an order of items in a set, upper bound values of a co-occurrence statistic, actual values of the co-occurrence statistic, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method executed by a computer processor, the method comprising:
computing, based on an upper bounding heuristic, upper bound values of a co-occurrence statistic for items in a set based on a query item, wherein the items in the set and the query item are represented by respective portions of a tensor;
sorting the items in the set into an order, wherein the upper bound values of the co-occurrence statistic for the items in the set are descending in the order; and
determining whether at least one of a top-K items in the order is associated with an upper bound value of the co-occurrence statistic, where K is a positive integer;
while at least one of the top-K items in the order is associated with an upper bound value of the co-occurrence statistic:
selecting an item from the order associated with a highest upper bound value of the co-occurrence statistic;
computing an actual value of the co-occurrence statistic for the selected item from the order based on the query item;
replacing the upper bound value of the co-occurrence statistic for the selected item with the actual value of the co-occurrence statistic for the selected item; and
repositioning the selected item in the order based on the actual value of the co-occurrence statistic; and
when the top-K items in the order lack an item associated with an upper bound value of the co-occurrence statistic, outputting the top-K items and actual values of the co-occurrence statistic for the top-K items.

2. The method of claim 1, wherein the co-occurrence statistic is an inner product between items.

3. The method of claim 1, wherein the tensor is a matrix and the portions of the tensor are one of columns of the matrix or rows of the matrix.

4. The method of claim 1, wherein the tensor is a three-dimensional datacube and the portions of the tensor are matrices of the datacube.

5. The method of claim 1, wherein the outputted top-K items comprise a subset of the items in the set having the K highest frequencies of co-occurrence with the query item.

6. The method of claim 1, further comprising computing the upper bound values of the co-occurrence statistic between the query item and each of the items in the set.

7. The method of claim 1, wherein the upper bounding heuristic comprises a first function that computes a p-norm of the respective portion of the tensor that represents the query item and a second function that computes a q-norm of the respective portions of the tensor that represent the items in the set, wherein p and q are selected to satisfy conditions of Holder's inequality.

8. The method of claim 1, wherein computing the upper bound values of the co-occurrence statistic for the items in the set based on the query item further comprises:
applying a first function to the portion of the tensor that represents the query item;
applying the second function to a given portion of the tensor that represents a particular item in the set;
multiplying an output of the first function and an output of the second function to compute an upper bound value of the co-occurrence statistic for the particular item in the set; and
repeating, for remaining items in the set, applying the second function to the respective portions of the tensor that represent the remaining items in the set and respectively multiplying the output of the first function and outputs of the second function to compute upper bound values of the co-occurrence statistic for the remaining items in the set.

9. The method of claim 8, wherein the first function and the second function are norms.

10. The method of claim 8, wherein one of the first function is a one-norm and the second function is an infinity-norm or the first function is the infinity-norm and the second function is the one-norm.

11. The method of claim 8, wherein the first function is a two-norm and the second function is the two-norm.

12. The method of claim 1, wherein actual values of the co-occurrence statistic are computed for a subset of the items in the set and computation of actual values of the co-occurrence statistic for a remainder of the items in the set is inhibited.

13. The method of claim 1, further comprising:
compressing the tensor to output a compressed tensor prior to computing the upper bound values of the co-occurrence statistic for the items in the set based on the query item; and
computing the upper bound values of the co-occurrence statistic for the items in the set using the compressed tensor.

14. The method of claim 13, further comprising applying one or more norms to elements in subblocks of the tensor to compress the tensor, wherein the subblocks of the tensor comprise respective pluralities of the elements of the tensor and wherein individual counts for the elements of the tensor are replaced by mixed-norms of the subblocks in the compressed tensor, and wherein the upper bound value of the co-occurrence statistic is an inner product of compressed tensors.

15. A system that identifies top-K items that co-occur with a query item, comprising:
a bound analysis component that computes upper bound values of a co-occurrence statistic for items in a set based on a query item, wherein the items in the set and the query item are represented by respective portions of a tensor;
an organization component that sorts the items in the set into an order, wherein the items in the set are arranged with the upper bound values of the co-occurrence statistic for the items in the set descending in the order;
a selection component that determines whether at least one of the top-K items in the order is associated with an upper bound value of the co-occurrence statistic, where K is a positive integer, and selects an item from the order associated with a highest upper bound value of the co-occurrence statistic when at least one of the top-K items in the order is determined to be associated with an upper bound value of the co-occurrence statistic;
a co-occurrence computation component that computes an actual value of the co-occurrence statistic for the selected item from the order based on the query item;
a replacement component that replaces the upper bound value of the co-occurrence statistic for the selected item with the actual value of the co-occurrence statistic for the selected item, wherein the selected item is repositioned in the order based on the actual value of the co-occurrence statistic; and
an output component that outputs the top-K items in the order when the selection component determines that the top-K items in the order lack an items associated with an upper bound value of the co-occurrence statistic.

16. The system of claim 15, wherein the output component further outputs actual values of the co-occurrence statistic for the top-K items.

17. The system of claim 15, wherein the bound analysis component applies a first function to a portion of the tensor that represents the query item, applies a second function to a portion of the tensor that represents a particular item in the set, and multiplies an output of the first function and an output of the second function to compute an upper bound value of the co-occurrence statistic between the particular item and the query item.

18. The system of claim 17, wherein the first function and the second function are norms selected to satisfy conditions of Holder's inequality.

19. The system of claim 15, further comprising a compression component that compresses the tensor to output a compressed tensor by applying one or more norms to elements in subblocks of the tensor, wherein the subblocks of the tensor comprise respective pluralities of the elements of the tensor, wherein individual counts for the elements of the tensor are replaced by counts for the subblocks in the compressed tensor, and wherein the bound analysis component computes the upper bound values of the co-occurrence statistic for the items in the set using the compressed tensor.

20. A computer-readable storage medium including computer-executable instructions that, when executed by a processor, cause the processor to perform acts including:
applying a first function that includes a first norm to a portion of a tensor that represents a query item;
for items in a set represented by the tensor other than the query item, applying a second function that includes a second norm to respective portions of the tensor corresponding to the items and respectively multiplying an output of the first function and outputs of the second function to compute upper bound values of an inner product for the items in the set, wherein the first norm and the second norm are selected to satisfy conditions of Holder's inequality;
sorting the items in the set into an order, wherein the upper bound values of the inner product for the items in the set are descending in the order; and
determining whether at least one of a top-K items in the order is associated with an upper bound value of the inner product, where K is a positive integer;
while at least one of the top-K items in the order is associated with an upper bound value of the inner product:
selecting an item from the order associated with a highest upper bound value of the inner product;
computing an actual value of the inner product for the selected item from the order based on the query item;
replacing the upper bound value of the inner product for the selected item with the actual value of the inner product for the selected item; and
repositioning the selected item in the order based on the actual value of the inner product; and
when the top-K items in the order lack an item associated with an upper bound value of the inner product, outputting the top-K items and actual values of the inner product for the top-K items.
